(19) United States
(12) Patent Application Publication
(10) Pub. No.: US 2014/0322013 A1
(43) Pub. Date: Oct. 30, 2014

(54) INDEPENDENT VARIABLE BLADE PITCH AND GEOMETRY WIND TURBINE CONTROL

(71) Applicant: Nikle Industries, LLC, Marion Center, PA (US)

(72) Inventors: Benjamin T. Elkin, Marion Center, PA (US); Brent T. Elkin, Imlay City, MI (US)

(21) Appl. No.: 14/323,744

(22) Filed: Jul. 3, 2014

Related U.S. Application Data
(63) Continuation-in-part of application No. 12/541,590, filed on Aug. 14, 2009.

(51) Int. Cl. F03D 7/04

(52) U.S. Cl. CPC F03D 7/041
USPC 416/131

(57) ABSTRACT

A variable blade pitch wind turbine and method of passively varying the blade pitch is presented. Each blade of the turbine rotor can individually and passively rotate about a respective blade axis to continuously vary the pitch of the blades to adjust to the ever changing wind speed and direction without active controls or other mechanical or electrical induced inputs to force rotational movement of the blades. Sections of each blade can respectively rotate to change the blade twist. In one example, a second rotor is used to improve the efficiency of the wind turbine and increase output of the electric generating equipment.

### RELATED APPLICATIONS

This application is a continuation-in-part and claims benefit of U.S. patent application Ser. No. 12/541,590, filed on Aug. 14, 2009, which is herein incorporated by reference in its entirety. This application is related to U.S. patent application Ser. No. 12/541,603, filed on Aug. 14, 2009, which issued as U.S. Pat. No. 8,454,313 on Jun. 4, 2013, both of which are herein incorporated by reference in their entirety.

### TECHNICAL FIELD

The general field of invention is alternative energy.

### BACKGROUND

There has long been motivation for alternative energy sources to reduce the dependency on non-renewable energy sources such as oil and coal. There has long been interest in harnessing wind to generate electricity, particularly in areas with a high or relatively continuous stream of wind energy.

There have been challenges with previously proposed solutions for harnessing wind energy through use of electric wind turbines. These large windmill-type structures suffer from many disadvantages, including the inability to adjust to variable wind conditions in either or both direction and velocity. Due to the size and mass of large wind turbines, it may be costly to adapt the wind turbine design to every possible operating environment. Prior wind turbines may also suffer from inefficient and complex designs.

Prior wind turbine configurations may suffer from relatively low efficiency rates due to standard configurations that are employed in operating environments not suitable for the particular wind turbine design or initial set-up. In an attempt to overcome these deficiencies, prior wind turbine designs may use various mechanisms, such as segmented blades, weights, flaps, actuators, sensors, motors and springs, in an effort to improve efficiency and control a rotational speed of the rotors to try and keep them from experiencing an overspeed condition. These prior configurations may also use additional forces, such as centrifugal force, centripetal force, and mechanical and electromechanical forces, to alter an aerodynamic orientation or shape of the blade in an attempt to control the rotational speed of the rotors. This in turn may cause a less efficient blade orientation and create a “governing” position that reduces the risk of encountering an overspeed condition at the expense of turbine efficiency.

Previously disclosed methods for estimating alignment of the blades with the wind source in both direction and blade angle of attack may also negatively affect efficiency. Blade alignment is typically determined using averaged data collected over a given time duration, not in real time. This may result in a less than optimal blade orientation for the current wind conditions and a corresponding drop in turbine efficiency.

Thus it is desirable to improve on prior wind turbine designs to increase the turbine's ability to harness the wind energy, improve the efficiency in converting the wind energy to electricity by responding quicker to wind speed and wind direction changes, enable the wind turbine to operate through a larger range of wind speeds, and to simplify and improve their design and operation.

### BRIEF SUMMARY

The present invention relates to electric wind turbines and methods for varying the orientation and/or shape of the rotor blades to better adapt to changing wind conditions and increase the capture of wind energy. One method of varying the shape involves varying the twist of the rotor blade as discussed in more detail herein.

In one example of the wind turbine invention, a first or front rotor and a second or rear rotor are used on opposing ends of the power transmission housing or nacelle. In alternate examples of this invention, the rotor blades include separate blade sections that are able to freely rotate relative to each section through a predetermined range to balance aerodynamic forces acting on the airfoils by passively adjusting an angle of attack for each blade section in response to changing wind speeds and conditions occurring at different positions along the path of rotation and thereby changing the orientation and/or twist of the entire blade.

In an alternate example, the individual rotor blade supports extend from a central hub and are able to rotate about the blade support axis independent of all other blade supports, and passively change the rotational position of the entire blade to balance the aerodynamic forces acting on the airfoils by passively adjusting an angle of attack of the blade in response to different wind speeds or changing wind conditions.

In an another example, both the separate sections of the individual rotor blade and the rotor blade support are able to rotate through predetermined ranges to further increase the adaptability of the wind turbine to the wind conditions.

In an alternate example of a two rotor design, the wind turbine acts similar to a turbine engine. The first rotor blades act like the stator blades in the turbine engine by setting up the wind for the rear rotor. The first rotor/stator blades also redirect the wind to provide a more efficient angle of attack on the second rotor blades. This stator and rotor effect increases the ability to harness the wind energy for increased electrical output and efficiency.

In an alternate example of a two rotor design, the first rotor blades are not as long as the blades on the downwind second rotor blades to provide a passive yaw condition that improves the ability to harness the wind energy for increased electrical output and efficiency.

In alternate examples where only a single rotor is used, the above mentioned examples of utilizing separate blade sections passively rotatable with respect to each section and/or passive rotation of the blade support relative to a central hub may be used depending on the geographic location and anticipated climate conditions.

The invention further includes a variable twist wind turbine rotor blade that passively adjusts the blade twist to balance the aerodynamic forces on the airfoils to adjust the angle of attack in response to the immediate wind conditions confronting the blade. The change or variation in twist, in one example, uses separate blade sections that are independently rotatable with respect to the blade support such that the change in rotation of the separate blade sections alters an overall shape of the airfoil or twist of the blade. In another example, the blade sections are rotatable with respect to other blade section(s). In a third example, the blade support is freely rotatable in a two dimensional plane parallel to the mounting surface with respect to a hub to change an orientation of a portion of the blade or the entire blade.

### BRIEF DESCRIPTION OF THE DRAWINGS

The description herein makes reference to the accompanying drawings wherein like reference numerals refer to like parts throughout the several views, and wherein:

FIG. 1 is a partial front perspective view of an exemplary wind turbine employing two rotors;

FIG. 2 is a partial front perspective view of the wind turbine of FIG. 1, with a nacelle removed to illustrate power generation equipment housed within the nacelle;

FIG. 3 is a front perspective view of a front rotor employed with the wind turbine of FIGS. 1 and 2;

FIG. 4 is a perspective view of a first or front blade assembly with individual blade sections shown arranged in an aligned design position;

FIG. 5 is a perspective view of the blade assembly of FIG. 4 with the individual blade sections shown arranged in an unaligned position;

FIG. 6 is an end view of a blade section that includes twist;

FIG. 7 is an enlarged partial view of a portion of a blade identified as A in FIG. 4;

FIG. 8 is an enlarged partial perspective view of a portion of a blade identified as B in FIG. 6 illustrating a pivot limiter;

FIG. 9 is a partial section taken along section lines 8-8 in FIG. 7 illustrating a bearing assembly;

FIG. 10 is a partial section taken along section lines 8-8 in FIG. 7 illustrating an alternatively configured bearing assembly;

FIG. 11 is an enlarged partial perspective view of a portion of a blade identified as A in FIG. 4 illustrating an alternatively configured pivot limiter;

FIG. 12 is a partial section taken along section line 11-11 in FIG. 10;

FIG. 13 is an end view of adjacent blade sections identified as 12 in FIG. 6, showing the blades sections in the aligned position;

FIG. 14 is an end view of adjacent blade sections identified as 13 in FIG. 6, showing the blade section in an unaligned position;

FIG. 15 is an end view of adjacent blade section identified as 14 in FIG. 6, showing the blade sections in a second unaligned position;

FIG. 16 is an end view of a blade section with a blade support positioned along a chord line of the blade; and

FIG. 17 is an end view of a blade section with the blade support located in an alternative position.

### DETAILED DESCRIPTION

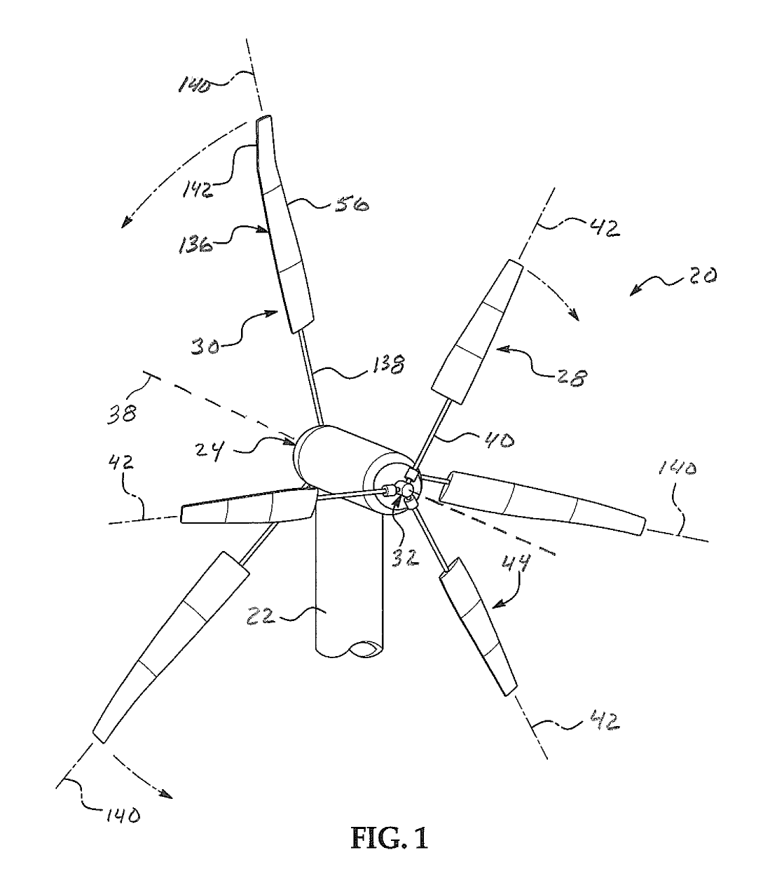

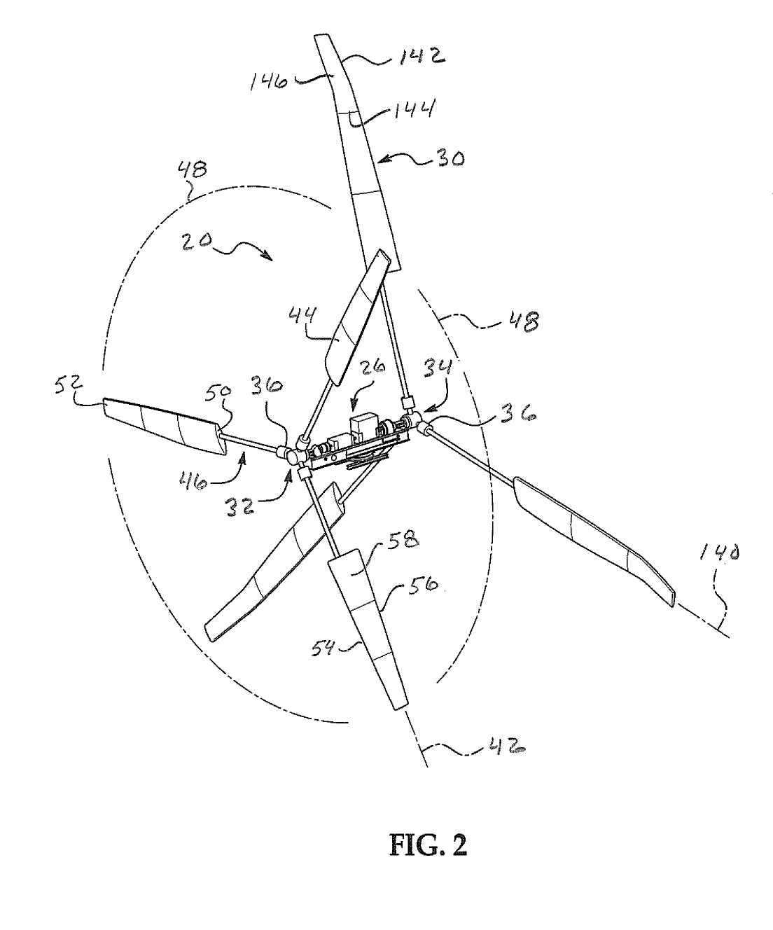

Various examples of an inventive wind turbine 20 are shown in FIGS. 1-17. With particular reference to FIGS. 1 and 2, a wind turbine 20 may include a tower 22 (partially shown) anchored to a foundation (not shown) secured to the earth by means known to those skilled in the field. Tower 22 is typically 200-300 feet in height depending on the application. Secured to a top of the tower 22 is a nacelle 24 that houses power generation equipment 26 (see FIG. 2). Although the nacelle 24 is illustrated atop tower 22, it is within the scope of the invention that the nacelle 24 could be mounted to other structures or towers of alternate heights and tower constructions.

In the example shown in FIGS. 1 and 2, wind turbine 20 includes a front rotor 28 positioned at one end of the nacelle 24 and a rear rotor 30 positioned at the opposite end of the nacelle 24, as generally illustrated. Hereinafter, front rotor 28 is referred to as first rotor 28, and rear rotor 30 is referred to as second rotor 30. Each rotor 28, 30 includes a respective front hub 32 and rear hub 34.

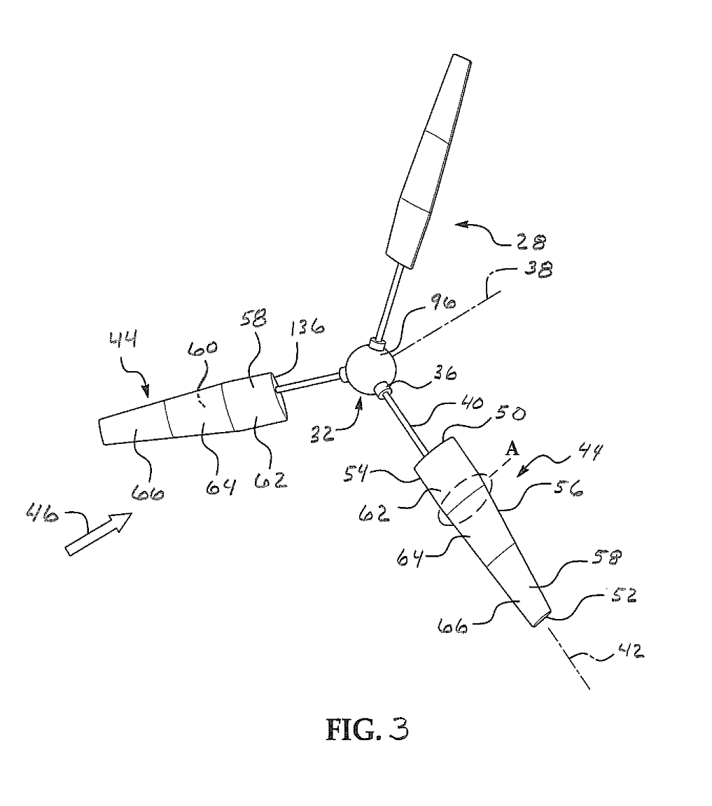

Referring to FIG. 3, an example of first rotor 22 is illustrated in detail. In one example, wind turbine 20 may include only first rotor 22 connected to the power generation equipment 26 located inside the nacelle 24. Alternatively, wind turbine 20 may include multiple first rotors 22, for example, arranged on opposite sides of the nacelle 24. The first rotor 22 may include at least two spindles 36 (three shown) connected to the front hub 32 and extending radially outward from a rotational axis 38, as generally shown. In the example illustrated, first rotor 28 includes at least two elongate front blade supports 40 (three shown). Blade supports 40 connect to first hub spindles 36 through a mounting collar and mechanical fasteners. Blade supports 40 extend radially outward from rotational axis 38, each defining a blade axis 42.

In one example of wind turbine 20, blade supports 40 are rigidly fixed to the spindles 36 and do not translate or rotate relative to spindles 36 or front hub 32. In an alternate example, blade supports 40 are configured to rotate relative to spindles 36 about blade axis 42. In this example, spindles 36 may include a bearing within spindle 36 to secure blade support 40 while permitting rotation about blade axis 42. Blade support 40 may be freely rotatable about blade axis 42 through a predetermined and limited angle of rotation through mechanical stops or barriers similar to that described later with respect to the blade sections. Rotation of blade support 40 is entirely passive in the illustrated embodiments. Wind turbine 20 does not use any electrical, electro-mechanical or mechanical mechanisms, including sensor, flaps, actuators, motors, springs or flyweights, to impart a force or energy to forcibly rotate blade support 40 relative to the respective spindle 36. Rather, the force that produces rotation of blade support 40 relative to spindle 36 is the result of aerodynamic forces acting on a blade 44 attached to blade support 40 that act to passively adjust an angle of attack of blade 44 to help optimize performance and efficiency of the wind turbine 20.

Blade supports 40 radially extend from the rotational axis 38 and define a geometric plane 48 through which part, or substantially all, of blade supports 40 lie in and rotate through in operation. In one example, blade supports 40 are hollow, rigid tubular rods made from steel. Other lengths and numbers of blade supports 40, as well as different materials and mechanical connections may be used without deviating from the invention. In one example, blade supports 40 are made from composite materials, such as carbon fiber reinforced resin.

With continued reference to FIGS. 1-3, an example of first rotor 28 includes three blades 44 connected to a respective blade support 40 and extending radially outward along blade axis 42. Blades 44 include an inner end 50 and a radially distant outer or distal end 52. Each blade 44 includes a leading or cutting edge 54, which is the first portion to contact air in the direction of rotation (clockwise about rotational axis 38 as viewed from the perspective of FIG. 3), and a trailing edge 56 on an opposite side of the blade 44. The ends 50, 52 and edges 54, 56 define a perimeter of a wind bearing surface 58 and an opposing leeward surface 60 on the opposite side of the blade 44. Wind bearing surface 58 substantially faces toward wind source 46.

Blade 44 may be made from a variety of materials, including, but not limited to, reinforced resin or polycarbonate. An outer skin of the blade 44 defines a substantially hollow interior cavity that may include internal reinforcing ribs as needed to meet a particular application and performance requirements. Other materials, such as lightweight ferrous and non-ferrous metals, composites, as well as other materials and constructions, may be also be employed. Although three blades 44 for first rotor 28 are illustrated, alternatively a greater or less number of blade supports 40 and associated blades 44 may be used to suit particular application and performance requirements.

In one example of wind turbine 20, first rotor blades 44, when assembled and connected to the respective blade supports 40, form a single piece blade unit that is rigidly fixed to blade support 40. Blade 44 does not translate or rotate relative to blade support 40. Instead, blade support 40 supporting the single unit fixed blade 44 is capable of rotating about blade axis 42 with respect to first hub spindle 36, as previously described. Rotation of blade support 40 adjusts, modifies or varies an angle of attack of the respective blade 44 relative to the wind source 46. Blade support 40 and blade 44 passively rotate in substantial unison in response to changes in the aerodynamic forces acting along the pressure and leeward surfaces 58, 60 of the blade 44, respectively, to increase an ultimate power output of generator 26 and/or increase an efficiency with which power is generated. Passive rotation of blade support 40 and blade 44 occurs without active controls or other artificially generated (e.g., electrical or mechanical) forces, and is in response to the aerodynamic forces acting on the blade 44. Changes in the wind source 46, such as speed and direction, affect the aerodynamic forces acting on blade 44 and cause support 40 and blade 44 to rotate relative to spindle 36 to adjust the angle of attack of blade 44. As described in greater detail subsequently, the response characteristics of blade 44 to changes in wind source 46 may be tailored for a particular application by adjusting the location of blade support 40 relative to a maximum thickness of blade 44. The position of blade support 40 (which defines the blade axis of rotation 42) relative to blade 44 determines, at least in part, how blade 44 responds to changes in the wind source 46 to change the angle of attack. The passively adjustable control system for regulating the angle of attack of blade 44 operates continuously in real time to accommodate changes in wind source 46 to optimize the performance and efficiency of wind turbine 20.

Blade 44 may alternatively be rotatably attached to support 40, rather than configuring blade 44 and blade support 40 as a unitized structure that rotate together, as previously described. With this configuration, blade support 40 may be prevented from rotating relative to spindle 36. Blade 44 may include one or more bearings, which may be configured substantially the same or similar to that shown in FIGS. 9 and 10, and as further described below, for mounting blade 44 to blade support 40.

With reference to FIGS. 4 and 5, blades 44 may include multiple sections that may be independently pivoted relative to one another to vary a twist of blades 44. Each blade 44 may be divided or separated into at least two sections that can rotate relative to blade support 40 about blade axis 42. In the illustrated example, blade 44 includes a first blade section 62, a second blade section 64 positioned adjacent and radially outward of first blade section 62 along blade support 40, and a third blade section 66 positioned adjacent and radially outward of second section 62. Second blade section 64 is disposed between first blade section 62 and third blade section 66. Alternatively, blade 44 may be divided into fewer or more blade sections to accommodate the design and performance requirements of a particular application. Unlike the previously discussed example, where blade 44 is rigidly fixed to blade support 40, each of first 62, second 64 and third 66 blade sections may be rotatably connected to blade support 40 to permit rotation of the respective section about support 40 and blade axis 42 independent of the adjacent blade sections.

In FIG. 4, each of the three blade sections 62, 64 and 66 is shown aligned with the adjacent blade section. This arrangement may be referred to as the “aligned” or “design” position. In this position a longitudinal end of a particular blade section is aligned generally with a longitudinal end of an adjacent blade section to produce a design twist of the blade.

Each blade section 62, 64 and 66 is free to rotate about blade axis 42 independent of the other. The twist in blade 44 may be modified by rotating one or more of the blade sections 62, 64 and 66 relative to one another about support 40 to independently optimize an angle of attack of the individual blade section for the wind source 46. For example, in FIG. 5 blade sections 62, 64 and 66 are shown in an “unaligned” position. In this configuration one or more of the blade sections 62, 64 and 66 have passively rotated relative to the other blade sections in response to the aerodynamic forces acting on the individual blade sections 62, 64 and 66 caused by wind source 46 passing over the blade sections. In the exemplary arrangement shown in FIG. 5, blade section 64 is rotated clockwise (as viewed from a perspective looking inward from the tip 52 of blade 44 along blade axis 42) relative to blade section 62, and blade section 66 is rotated clockwise from blade section 64. Each blade section 62, 64 and 66 may also be rotated in an opposite direction, for example, counter-clockwise. In practice, the angular rotation of blade sections 62, 64 and 66 about blade axis 42 may be more or less than shown in FIG. 5, and each blade section may rotate more or less than the other blade sections. The rotational positioning of the blade section 62, 64 and 66 relative to one another may remain fairly constant, or may periodically or continuously change depending on the consistency of wind source 46.

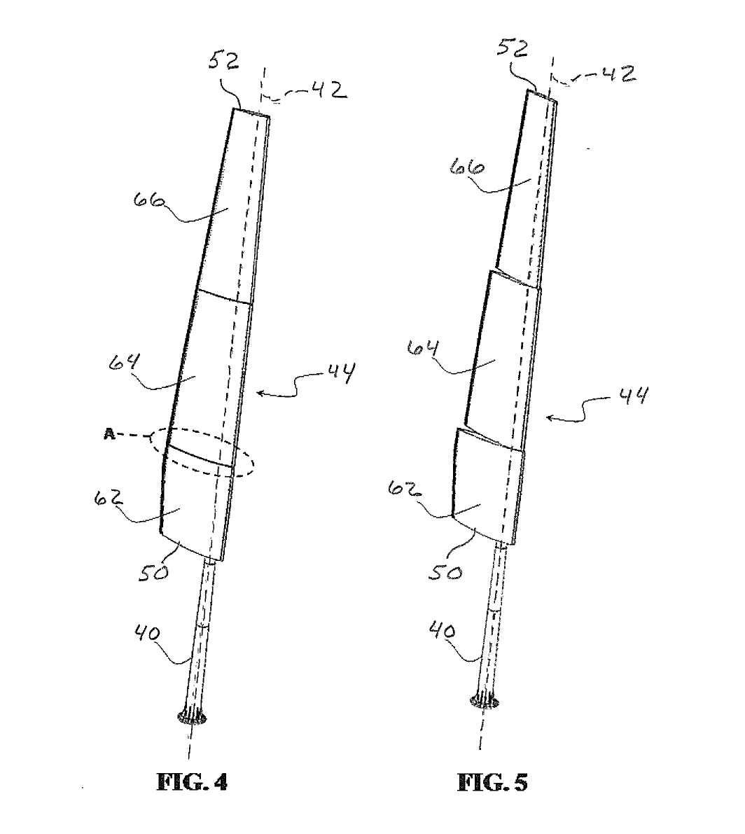

The blade 44 and blade sections 62, 64 and 66 may be configured as a substantially straight blade or may include a twist. The exemplary blade 44 and blade sections 62, 64 and 66 are illustrated in the figures as having little or no twist. Alternatively, the blade 44 and one or more of the blade sections 62, 64 and 66 may include a twist. An example of a twisted blade section 62 is illustrated in FIG. 6. The twist results in the leading edge 54 of the blade being angularly rotated at a radial outer section of the blade (for example, at second end cap 70) relative to a radial inner section of the blade (for example at first end cap 68). All or a portion of the blade 44 and blade sections 62, 64 and 66 may include a twist. It is not necessary that the twist be uniform along the entire length of the blade or blade section. One or more of the blade sections 62, 64 and 66 may include a twist, and if one blade section includes twist it is not necessary that the other blade sections also include a twist. For example, blade 44 may include a combination of twisted and straight blade sections.

With reference to FIG. 6, each of the blade sections 62, 64 and 66 includes a first end cap 68 radially closer to the rotational axis 38 (see FIG. 1) and a second end cap 70 radially distant from the first end cap 68. The first and second end caps 68 and 70, in combination with the previously described portions of the blade wind bearing surface 58 and leeward surface 60, generally provide a closed section defining a hollow cavity interior 72 within blade 44.

With reference to FIGS. 9 and 10, the individual blade sections may be rotatably connected to support 40 through one or more bearings 74. Bearing 74 may include various configurations. For example, with particular reference to FIG. 9, bearing 74 may include a roller bearing 76 having an outer race 78 connected to first end cap 68, an inner race 80 fixedly connected to blade support 40 and multiple ball bearings 80 slidably disposed between outer race 76 and inner race 78. Roller bearing 76 may be positioned within interior cavity 72 of a respective blade section (for example, second section 64 as illustrated in FIGS. 4 and 5). Outer race 78 may be connected to either first end cap 68 or second end cap 70 using fastener 84, depending on which end of a blade section the bearing is located. Inner race 80 may be connected to blade support 40 using fasteners 86.

With reference to FIG. 10, bearing 74 may alternatively be configured to include concentric interlocking guides. For example, bearing 74 may include an outer guide block 88 rotatably engaging an inner guide block 90. The guide blocks 88 and 90 may be located within interior cavity 72 of a respective blade section, for example second section 64 (see FIGS. 4 and 5). Outer guide block 88 may be connected to either first end cap 68 or second end cap 70 using fastener 84, depending on which end of a blade section the bearing is located. Inner guide block 90 may be connected to blade support 40 using fasteners 86. Alternatively, inner guide block 90 may be configured as an integral part of blade support 40. Inner guide block 90 may include one or more flanges 92 extending radially outward from an outer perimeter of the inner guide block. Flanges 92 slidably engage corresponding slots 94 extending around an inner circumference of the outer guide block 88. Similarly, outer guide block 88 may include one or more flanges 96 extending radially inward from the inner circumference of the outer guide block 88. Flanges 96 slidably engage corresponding slots 98 extending circumferentially around the outer perimeter of inner guide block 90.

It is understood that other forms of bearings and ways to enable rotation of the blade sections about support 40 and blade axis 42 may be used. It is further contemplated that bearing 74 may be positioned in other orientations, for example other than in the interior cavity 72 of the blade section.

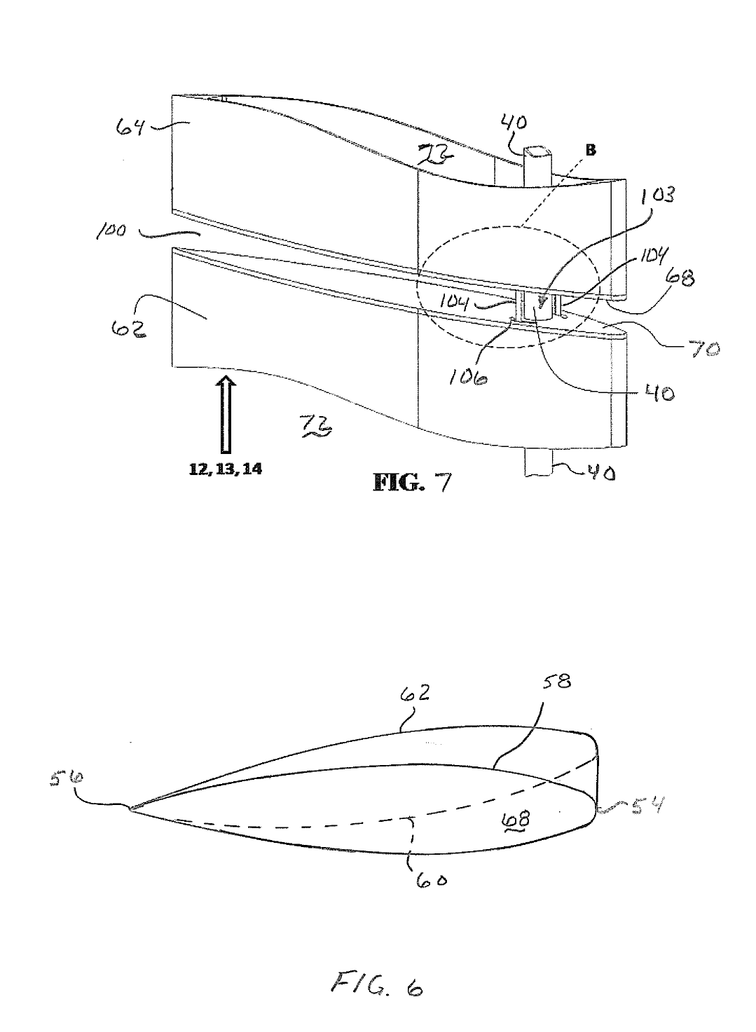

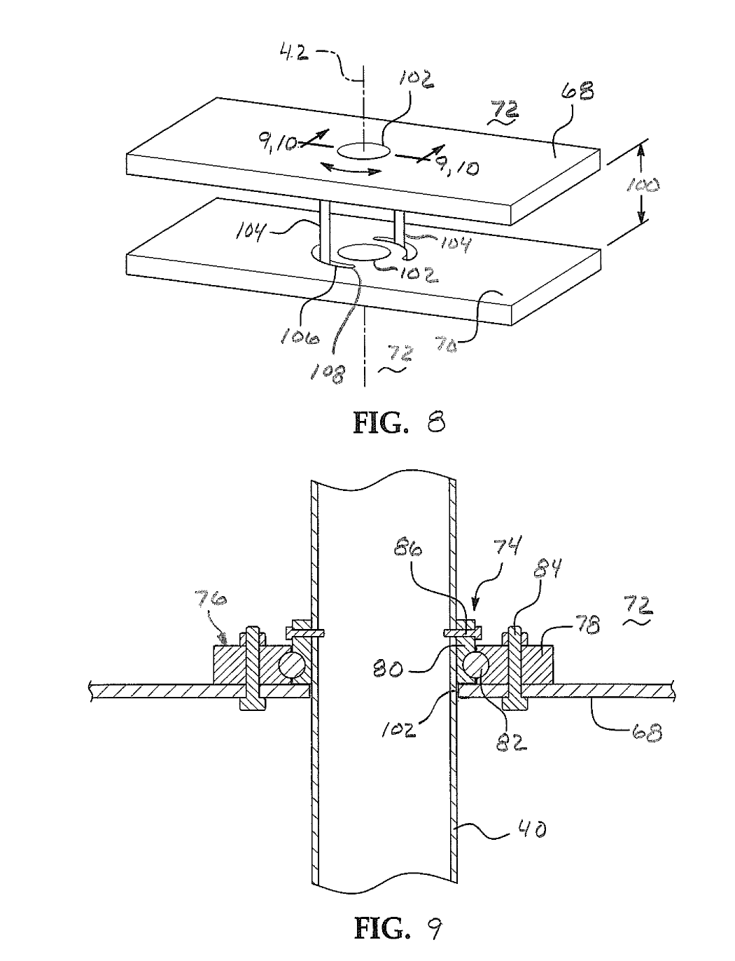

With reference to FIG. 7, blade configurations employing separate blade sections rotatable with respect to one another may include a clearance or gap 100 between adjacent blade sections. Gap 100 may serve several purposes, for example, reducing frictional contact between adjacent sections as they are capable of rotation relative to one another and providing clearance for additional components positioned between the sections. For example, bearings 74 (see FIGS. 9 and 10) may be positioned outside blade interior cavity 72 between adjacent blade sections. It is desirable for aerodynamics, however, that clearance or gap 100 be minimized.

With continued reference to FIG. 7, the blade sections may employ a blade section pivot limiter 103 for controlling the maximum amount or degree of angular movement about blade axis 42 that can take place between adjacent blade sections. Although illustrated as being used in connection with blade sections 62 and 64, pivot limiter 103 may also be used to limit the maximum amount of angular movement about blade axis 42 between blade sections 64 and 66. Continuing to refer FIG. 7, blade support 40 passes through apertures 102 extending through the blade end caps, for example, second end cap 70 of the first blade section 64 and the first end cap 68 of the second blade section 64. In the illustrated example, to limit or control the maximum rotation about blade axis 42 of second blade section 64 relative to first blade section 62, two pins 104 may be secured to first end cap 68. Pins 104 may be oriented to extend axially down from first end cap 68 and into angular slots 106, as generally shown. On rotation of second section 64 relative to first section 62, a predetermined maximum amount of angular differentiation is achieved through a hard mechanical stop of the pins 104 at ends 108 of the slots 106. Pins 104 may be made from ferrous or non-ferrous metals, or other materials suitable for a particular application.

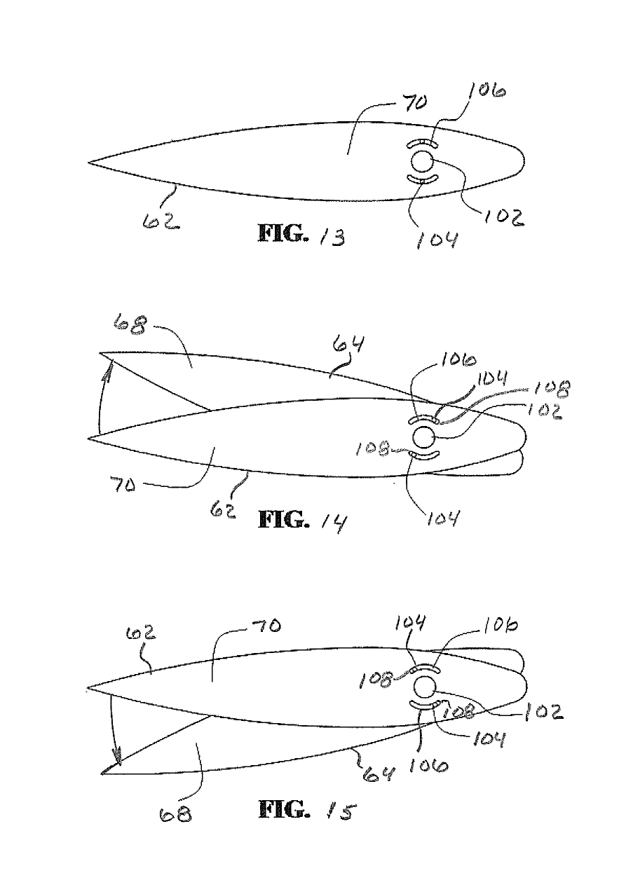

With reference also to FIGS. 13-15, in one example of angular slots 106 and pins 104, a nominal blade section orientation is established, for example, at the time of installation, wherein pin 104 is positioned in an approximate center of the respective slots 106 in a middle portion between the two extreme ends 108 of the slots, as shown for example in FIGS. 7 and 13. The nominal blade section orientation corresponds to the aligned position, as illustrated for example in FIG. 4. In this example, the predetermined maximum angular movement of pins 104 in the respective slot 106 is plus and minus thirty degrees about blade axis 42. In other words, the blade section predetermined maximum angular movement or range of movement is up to clockwise thirty degrees or up to counterclockwise thirty degrees about blade axis 42 from the nominal, aligned position. For example, in FIG. 14 blade section 64 is illustrated rotated clockwise (as viewed from the perspective of FIG. 14) relative to blade section 62. In the illustrated example, blade section 64 is positioned at nearly the maximum clockwise angular position allowed by pivot limiter 103, as indicated by the location of the pins 104 adjacent the end 108 of the slot 106. In FIG. 15, blade section 64 is illustrated rotated counter-clockwise (as viewed from the perspective of FIG. 15) relative to blade section 62. In the illustrated example, blade section 64 is positioned at nearly the maximum counter-clockwise angular position allowed by pivot limiter 103, as indicated by the location of the pins 104 adjacent the end 108 of the slot 106. Although blade section 64 is described in this example as rotating relative to blade section 62 about blade support 40, it is also possible for blade section 62 to rotate relative to blade section 64, or for both blade sections to rotate about blade support 40. The limitation being that the maximum relative angular rotation between the blade sections not exceed the maximum allowed by pivot limiter 103.

Although FIG. 7 illustrates where the pins 104 and slots 106 are positioned or integral within the end caps 68 and 70 of adjacent blade sections, these structures may take other forms, for example a separate plate or collar positioned in the gap 100.

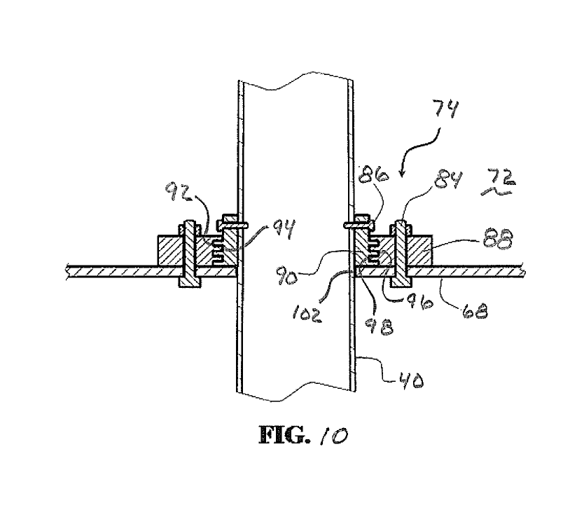

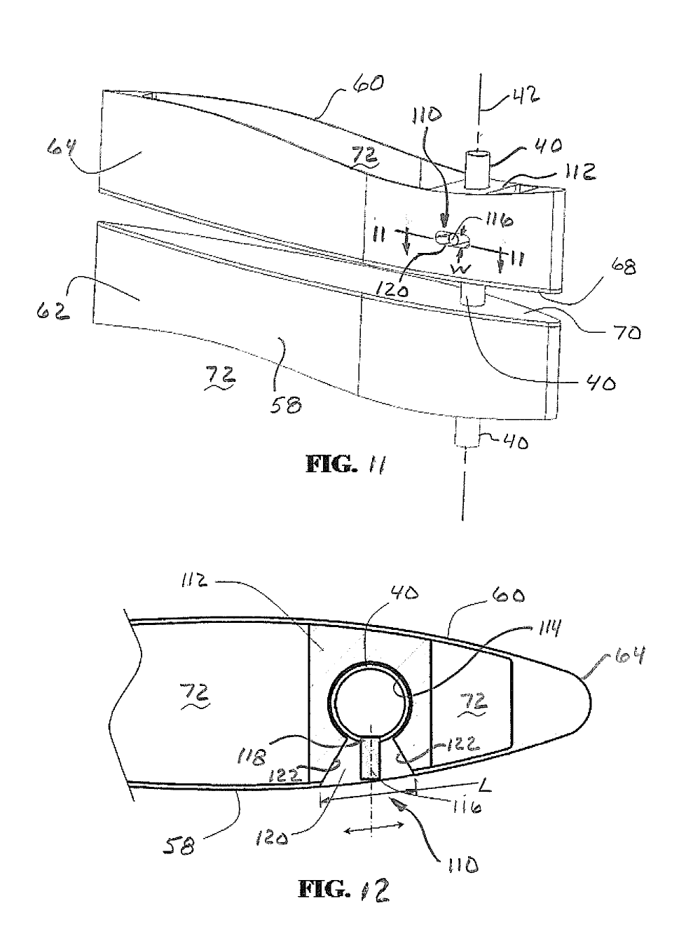

With reference to FIGS. 11 and 12, an alternately configured pivot limiter 110 for limiting the maximum amount or degree of angular rotation of the blade sections about blade axis 42 is illustrated. Although shown employed in connection with blade section 64, pivot limiter 110 may also be used to limit the maximum relative angular rotation between other blade sections, such as blade sections 64 and 66. With continued reference to FIGS. 11 and 12, blade support 40 extends through second end cap 70 of first blade section 62 and first end cap 68 of the second blade section 64, substantially as previously described in connection with pivot limiter 103. A stop block 112 may be positioned within the interior cavity 72 of the blade section between the wind bearing surface 58 and the leeward surface 60. The stop block 112 may be attached to one or both of the wind bearing and leeward surfaces 58 and 60, respectively. The stop block 112 includes an aperture 114 through which the blade support 40 extends. The stop block and the blade section 64 may freely rotate around the blade support 40 within predetermined limits determined by the configuration of the pivot limiter 110. The stop block 112 may extend an entire axial length of the blade section or only a portion. More than one pivot block 112 may be disposed within a blade section.

The pivot limiter 110 may include an elongated stop pin 116. An end 118 of the stop pin 116 may be attached to the blade support 40. The stop pin 116 extends generally radially outward from the blade support 40. At least a portion of the stop pin 116 is movably positioned within an elongated slot 120 formed in the pivot block 112. The slot 120 may extend entirely through the pivot block 112 and be open to an exterior of the blade section, as illustrated for example in FIGS. 11 and 12, or may alternatively extend only partially through the pivot block 112. The slot 120 may include a longitudinal length L that may be greater than its width W. The longitudinal axis of the slot 120, which extends axially along the longitudinal length of the slot, may be oriented generally perpendicular to the blade axis 42.

The length L of the slot 120 determines the maximum allowable axial rotation of blade section 64 relative to blade section 62. On rotation of second section 64 relative to blade support 40, a predetermined maximum amount of angular rotation may be achieved through a hard mechanical stop of the stop pin 116 at an end 122 of the slot 120. Stop pin 116 may be made from ferrous or non-ferrous metals or other materials suitable for the particular application. Structures other than the pin 116 and slot 120 may be employed as a stop for controlling the maximum angular rotation of the blade section.

In one example, the axial lengths of the individual first 62, second 64 and third 66 blade sections between first end cap 68 and second end cap 70 along blade axis 42 are not equal to reduce potential harmonic motion conditions or effects. It is understood that equal length blade sections may also be used with that consideration in mind or otherwise addressed through other measures.

One way of determining the axial lengths of the individual sections of blade 44 is to consider the blade twist. Conventionally, wind turbine blades are not “flat” in their geometry. They are designed with a twist such that the ratio of the rotational speed of the tip versus the wind speed is approximately 8:1, so that a blade has a change in angle along the blade length. For example, the blade at one-eighth of the axial length from the tip experiences only one degree difference in the angle relative to the tip, while the innermost eighth of the blade experiences a 45 degree difference in the angle relative to the tip. In theory, a large number of blade sections are desirable such that the change in the angle over the length of each section would be minimized and roughly equal to the other sections. Such a design would provide the most efficient use of the wind. It would also give an infinite number of cross section speed ratios and closely match any wind speed. In practice, however, manufacture of multiple sections is difficult, and multiple sections increase part count and maintenance expenses. Balancing these consideration results in one possible design described herein, where first 62, second 64 and third 66 blade sections are used. Although illustrated with three separate sections, first blade section 62, second blade section 64 and third blade section 66, it is understood that a fewer or greater number of blade sections may be used to suit the particular application or performance requirements.

The wind source 46 flowing over the blade 44 or blade sections 62, 64 and/or 66 generate aerodynamic forces acting along the wind bearing surface 58 and leeward surface 60 of the blade or blade section. The aerodynamic forces may result in a pitching moment tending to rotate the blade or blade section around the blade pivot axis 42. Changes in the wind source 46, such as wind speed or direction, may alter the aerodynamic forces and resulting pitching moment acting on the blade or blade section. Adjusting the angle of attack or twist of the blade or blade section may also cause changes in the aerodynamic forces and pitching moment acting on the blade or blade section. The blade or blade section react to these changes by passively rotating clockwise about blade pivot axis 42, as shown for example in FIG. 14, or counter-clockwise, as shown for example in FIG. 15. Rotation of blade 44 or blade sections 62, 64 and/or 66 changes the angle of attack and/or twist of the blade or blade section relative to the wind source 46, which in turn alters the aerodynamic forces and resulting pitching moment acting in the blade or blade section. The blade or blade section will passively rotate in the appropriate direction until the aerodynamic forces are such that the resulting pitching moment is substantially zero. This process will continue whenever there are changes in the wind source 46.

Due to the passive nature of the permitted rotation, the blade 44 or blade sections 62, 64 or 66 freely rotate with respect to blade support 40 within the limits imposed by pivot limiter 110. In the example of pivot limiter 110 using pins 116 and slots 106, as shown for example in FIG. 7, the pins 116 will “float” or freely move within the slot 106 to allow continuous adjustment of the blade or blade section orientation or blade twist to compensate for changes in the aerodynamic forces and pitching moment acting on the blade 44 or individual blade sections 62, 64 and 66 without further controls or other generated stimulus from the wind turbine 20. In the alternate example described, the blade sections 62, 64 and/or 66 will further rotate relative to one another for added adjustment to the blade twist as they rotate about blade pivot axis 42.

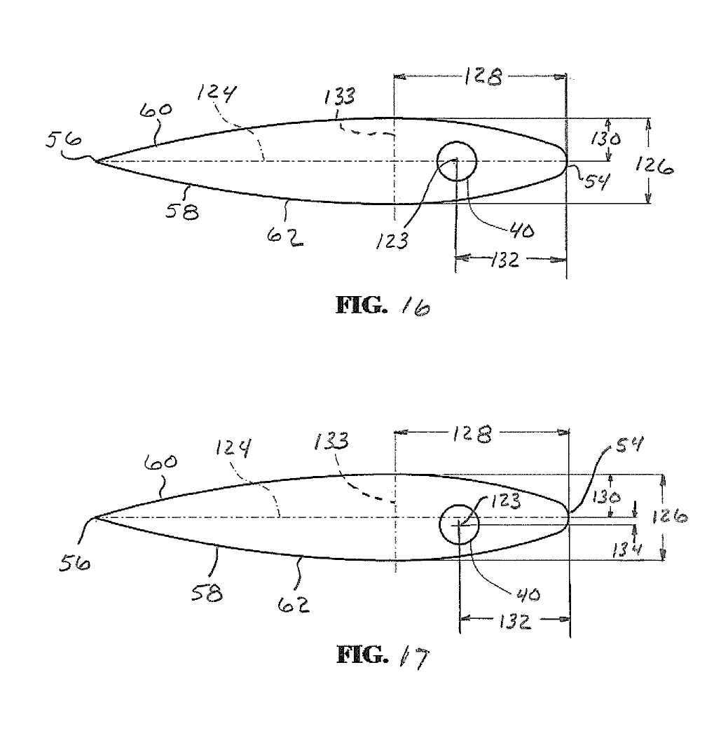

With reference also to FIGS. 16 and 17, the response characteristics of the blade 46 or blade sections 62, 64 and 66 to changes in the wind source 46 to maintain an optimum angle of attack for the prevailing wind conditions may be controlled by selective placement of the blade support 40 within the blade or blade section. For purposes of discussion, blade section 62 is illustrated in FIGS. 15 and 16, but the control method is also applicable to the blade 46 and blade section 64 and 66. A pivot point 123 of blade section 62 about blade pivot axis 42 coincides substantially with a center of blade support 40. One option for controlling the response characteristic of the blade is to position blade support 40 along a chord line 124 of the blade section 62. Exemplary blade section 62 is shown configured as a symmetrical non-cambered airfoil, with the chord line 124 substantially centered between the wind bearing surface 58 and leeward surface 60 along the entire length of the blade section. Because blade section 62 is substantially symmetrical, the chord line 124 also coincides with a camber line of the blade.

Dimension 126 represents a maximum thickness of the blade section 62 measured perpendicular to the cord line 124, which for this particular blade section occurs at a distance 128 from the blade leading edge 54. Due to the symmetry of blade section 62, the chord line 124 bisects the blade, such that a dimension 130 measured perpendicular from the chord line 124 to the blade surface at the blade maximum thickness is substantially half the maximum blade thickness 126. Dimension 132 is a distance measured along the cord line 124 from the blade leading edge 54 to the pivot point 123, or center of the blade support 40. The blade support 40 is preferably positioned forward of a maximum thickness plane 133, coinciding with the maximum blade thickness, to provide an aerodynamically stable airfoil capable of passively responding to changes in wind conditions by pivoting the blade section 62 to maintain a suitable angle of attack. Generally, the closer blade support 40 is positioned to the maximum thickness plane 133 the less aerodynamically stable the blade will be. Preferably the blade support 40 is positioned relative to the maximum thickness plane, such that dimension 132 is not more than approximately 95% of dimension 128 to create an aerodynamically stable airfoil.

Positioning the blade support 40 outside of the preferred range (i.e., distance 132 between 0-95% of distance 128) may require the use of additional control mechanisms to accommodate the aerodynamic instability that may occur and to maintain control of the blade orientation, and in particular, blade angle of attack. For example, the blade may require use of adjustable trailing and/or leading edge flaps capable of actively modifying the aerodynamic shape and/or orientation of the blade to accommodate the unstable forces acting on the airfoil as a result of locating blade support 40 outside the preferred range. This may of course add considerable cost, weight and complexity to the wind turbine. Also, it may not be feasible to employ movable flaps if the blade section includes twist, such as shown for example in FIG. 6. Wind turbine 20 does not require use of any additional controls, such as flaps, to maintain control over the orientation of the blade relative to the wind source 46. The aerodynamic shape of the blade section 62 does not change as the blade section passively rotates about the blade support 40 in response to changes in the wind source 46. Selective placement of the blade support 40 within the blade section as a means for controlling the response characteristics of the blade may be used effectively with blades having straight and/or twisted sections. Dimension 132 may change based on the position of the particular chord in the blade section.

In an alternative configuration illustrated for example in FIG. 17, the pivot point 123 may be positioned offset from the chord line 124 by a distance 134. In this configuration the pivot point is still positioned forward of the maximum thickness plane 133 and is located at a distance of not more than 95% of the distance 128 from the leading edge 54. This configuration also results in an aerodynamically stable airfoil capable of passively altering the aerodynamic forces and corresponding pivot moment acting on the blade by rotating the blade about the blade support 40 to maintain an optimum blade angle of attack for the prevailing wind conditions.

In the exemplary configuration shown in FIGS. 1 and 2 and described with reference to power transmission equipment 26 above, wind turbine 20 may include the second or rear rotor 30. Second rotor 30 may include the same construction and configuration as described for first rotor 28. For example and without limitation, second or rear rotor blades 136, like first rotor blades 44, may be of the configuration where each blade 136 is one unit fixed to a respective blade support 138 and wherein the blade supports 138 themselves rotate about blade axis 140 relative to the second hub 34. In the alternative, as described above with respect to first rotor blades 44, second rotor blades 136 may include separate blade sections that are capable of rotational movement with respect to the respective blade support 138 and one another through the structures described. Construction of second hub 34 can be the same as first hub 32.

One difference between the first rotor 28 and the second rotor 30 is that, in a preferred configuration, second rotor 30 rotates in an opposite direction about rotational axis 38 relative to first rotor 28. In the example shown in FIGS. 1 and 2, the second rotor 30 rotates in a counter-clockwise direction (as viewed from the perspective of FIG. 1), and thus the leading edge is on the opposite side of the blade when compared to blades of the first rotor 28. The blade orientation of the second rotor 30 is also different from the first rotor 28 in this configuration due to the opposite rotation. This counter-rotation between the first and second rotors 28 and 30 provides the benefit of reducing the torsional forces and stresses on the nacelle 24 and tower 22 through at least partial cancellation of opposing forces.

With continued reference to FIGS. 1 and 2, second rotor 30 has a second set of blades 136 longer than blades 44 of the first rotor 28 and that extend past the distal or radially-extreme end 52 of the blades 44 of the first rotor 28. In these lengths and orientations, there is a blade sweep overlap between the blades of the first rotor 28 and those of the second rotor 30, which is the distance between the radially lowest end of the second set of blades 136, and the radially distant or top of the first set of blades 44. This overlap is useful to increase the efficiency of the wind turbine 20 by extracting additional wind energy with the second rotor 30 from the same wind that already encountered the first rotor 28. That is, the counter rotating and expanding vortex from the first set of (front) blades 44 is at least partly captured by the second set of (rear) blades 136.

Through having the second rotor 30 and the described orientation of the blades with respect to one another, the second rotor 30 provides additional conversion of wind energy into electricity over prior single blade assembly designs. The wind turbine design acts similar to a turbine engine. The first rotor blades act like the stator blades in the turbine engine by setting up the wind for the rear rotor. The first rotor 28 also redirects the wind to provide a more efficient angle of attack on the second rotor blades 136. The difference in this wind turbine design, as shown for example in FIG. 2, is that the first rotor 28 rotate unlike the stationary turbine engine stator blades. The first rotor 28 and second rotor 30 are both connected to a common shaft for driving the power generation equipment 26, therefore producing more power than a stationary stator system or single rotor design.

With particular reference to FIG. 2, one example of the second rotor 30 includes an angled blade portion 142 near the distal end of blades 136. As illustrated, this angled portion 142 may be biased toward the first rotor 28. A suitable angle of portion 142 from the remaining portion of the blade 136 is up to about forty degrees with respect to the blade axis 140, although other angles may be used depending on the application and performance requirements. In the example where blades 136 include multiple sections, angled portion 142 is preferably not at a joint or gap 144 between adjacent sections, but may be depending on the application and performance requirements. Alternatively, a tip section 146 of blades 136 may be substantially straight, similar to first rotor blades 44, depending on the performance requirements of the particular application.

In operation, a two rotor configuration creates an added benefit of passive yaw control. The rotor/stator effect of the first rotor 28, as described above, sets a direction of the wind source 46 into the second rotor 30. The second rotor 30, due to the longer blade length and counter rotating rotor, acts as a tail to cause the first rotor 28 to steer into the wind source 46. This steering effect is a result of the wind source 134 interacting with the wind turbine 20, eliminating the need to use any electrical, mechanical or electro-mechanical mechanisms to control the orientation of the wind turbine relative to the wind source.

As described above, the orientation of blades 44 of first rotor 28 passively adjust according to the wind conditions at the point of contact with the respective blade wind bearing surface 58. The blade 44 or respective blade sections, 62, 64 and 66, will rotate relative to blade support 40, and in the examples illustrated, with respect to adjacent blade sections about blade axis 42. There are no electrical, mechanical or electro-mechanical actuators, mechanisms or links interconnecting the blades. This enables independent passive variation of the blade orientation, and optionally the geometry or twist of the blades, to occur continuously throughout the rotation of the rotor about rotational axis 38 based solely on the aerodynamic forces acting on the blade to achieve an optimized angle of attack in response to the varying wind conditions provided by wind source 46.

In operation, where a variation in blade orientation is desired to accommodate changes in wind speed and direction, several optional methods have been disclosed. The blades 44 and 136 may be configured to be a single unit fixed to a rotatable blade support 40 138, respectively, a multi-section blade wherein the blade sections are capable of rotating with respect to one another, a multi-section blade wherein the blade sections are mounted on a fixed blade support 44 and are capable of rotating independently of one another with respect to the fixed blade support 44, or an example where the blade includes both the rotatable blade sections as well as a rotatable blade support 44, 138. In each of the examples, the individual blade sections and/or the blade support 44, 138 are capable of independently and passively rotating through their predefined angles of movement to adjust or accommodate changing wind conditions. This independent passive adaptability, for example to accommodate often different wind speeds and directions at the lowest point in the swept area of the blade 44, 136 rotation versus wind speed and direction at the apex of blade 44, 136 rotation about rotational axis 38 at any given moment, provides a significant advantage over prior designs by increasing efficiency of operation and electrical output. Note that although all blade sections of a multi-section blade are described in the example as freely rotating, one blade section of the three, or more blade sections where there are more than three blade sections, could be fixed to the blade support 40, 138.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A wind turbine comprising:
a first rotor rotatable about an axis of rotation, the first rotor comprising;
a hub rotatable about an axis of rotation;
an elongate blade support extending radially outward from the hub, the elongate blade support defining a blade pivot axis;
a rotor blade attached to the elongate support and including a leading edge and a trailing edge, the rotor blade passively pivotable around the blade pivot axis in response to aerodynamic forces acting on the blade, wherein the blade pivot axis is positioned within a region of the blade extending between the leading edge and a section coinciding with a maximum thickness of the blade.

2. The wind turbine of claim 1, wherein a distance between the blade pivot axis and the blade leading edge does not exceed 95% of a distance from the leading edge to the blade section coinciding with the maximum blade thickness.

3. The wind turbine of claim 1, wherein the blade pivot axis intersects a chord line of the blade.

4. The wind turbine of claim 1, wherein the blade pivot axis is displaced from a chord line of the blade.

5. The wind turbine of claim 1, wherein at least a portion of the blade is twisted.

6. The wind turbine of claim 1, wherein the blade is pivotally connected to the blade support.

7. The wind turbine of claim 1, wherein the blade is attached to the blade support for concurrent rotation therewith, the blade support being rotatably connected to the hub.

8. The wind turbine of claim 1, wherein the blade comprises:
a first blade section and a second blade section, at least one of the first and second blade sections pivotably attached to the blade support and pivotable about the blade pivot axis relative to the second blade section.

9. The wind turbine of claim 8, wherein the rotation of the respective blade sections about the blade pivot axis is independent of the other blade section.

10. The wind turbine of claim 8, wherein at least one of the first and second blade sections includes a twisted portion.

11. The wind turbine of claim 8, wherein the second blade section is disposed radially outward from the first blade section along the blade pivot axis.

12. The wind turbine of claim 8, wherein the blade pivot axis is positioned within a region of the first and second blade sections extending between a leading edge of the blade and a section coinciding with a maximum thickness of the blade section.

13. The wind turbine of claim 1 further comprising:
a second elongate blade support extending radially outward from the hub, the second elongate blade support defining a second blade pivot axis;
a second rotor blade attached to the second elongate support and including a leading edge and a trailing edge, the second rotor blade pivotable around the second blade pivot axis, wherein the second blade pivot axis is positioned within a region of the second blade extending between the leading edge and a section coinciding with a maximum thickness of the second blade, wherein the rotation of the respective blades about their respective blade pivot axis is independent of the other blade.

14. The wind turbine of claim 1, further comprising:
an opposing second rotor separated from the first rotor along the rotational axis, the second rotor including a hub and a blade support radially extending from the hub and defining a blade axis, the blade support including a second rotor blade radially extending from the respective blade axis, wherein each second rotor blade end portion is angularly positioned with respect to the blade axis in a direction toward the first rotor along the rotational axis.

15. A wind turbine comprising:
a rotor rotatable about an axis of rotation, the rotor comprising;
a hub rotatable about an axis of rotation;
an elongate blade support extending radially outward from the hub, the elongate blade support defining a blade pivot axis;
a rotor blade including a first blade section and a second blade section, at least one of the first and second blade sections pivotably attached to the blade support and passively pivotable about the blade pivot axis relative to the other blade section in response to aerodynamic forces acting on the respective blade section, the first and second blade sections each including a leading edge and a trailing edge, wherein the blade pivot axis is positioned within a region of each the first and second blade sections extending between the leading edge and a section coinciding with a maximum thickness of the respective blade section.

16. The wind turbine of claim 15, wherein at least one of the first and second blade sections includes a twisted region.

17. The wind turbine of claim 16, wherein the second blade section is disposed radially outward from the first blade section along the blade pivot axis.

18. The wind turbine of claim 17, wherein at least one of the first and second blade sections is pivotable about the blade pivot axis between a first angular position and a second angular position, wherein an aerodynamic shape of the pivotable blade section remains substantially constant as the blade section pivots between the first and second angular positions.

19. The wind turbine of claim 17, wherein the first and second blade sections each include a predetermined fixed aerodynamic geometry.

20. The wind turbine of claim 15 further comprising:
a second elongate blade support extending radially outward from the hub, the second elongate blade support defining a second blade pivot axis;
a second rotor blade including a first blade section and a second blade section, at least one of the first and second blade sections pivotably attached to the second blade support and pivotable about the second blade pivot axis relative to the other blade section, the first and second blade sections each including a leading edge and a trailing edge, wherein the blade pivot axis is positioned within a region of each the first and second blade sections extending between the leading edge and a section coinciding with a maximum thickness of the respective blade section, wherein the rotation of the respective blade sections about their respective blade axis is independent of the other blade sections.

21. The wind turbine of claim 15, wherein the rotation of the respective blade sections about the blade pivot axis is independent of the other blade section.

22. The wind turbine of claim 15, wherein blade pivot axis intersects a chord line of the first and second blade sections.

23. The wind turbine of claim 15, wherein the blade pivot axis is displaced from a chord line of the blade.
